(19) United States
(12) Patent Application Publication
(10) Pub. No.: US 2007/0098846 A1
(43) Pub. Date: May 3, 2007

(54) Method for the production of food with slowed release of nutriments

(76) Inventors: Meikun Su, Berlin (DE); Yan Su, Berlin (DE)

Correspondence Address: L.C. BEGIN & ASSOCIATES, PLLC, 510 HIGHLAND AVENUE, PMB 403, MILFORD, MI, 48381, US

(21) Appl. No.: 11/583,673

(22) Filed: Oct. 18, 2006

(30) Foreign Application Priority Data
Oct. 18, 2005 (CN) 200510094957.8

(51) Int. Cl. A21D 2/00

(52) U.S. Cl. 426/18

(57) ABSTRACT

This is a method for the production of food that gradually releases its nutriments. This method belongs to the area of food technology. Within this food production process, refined seaweed flour will be added to cereal flour. The resulting cereal mixture flour will be processed into a variety of ready-to-serve meals via the normal food processing methods. The food additive calcium will be added either before consumption, or during the later phase of the food processing. Due to the consolidating quality of the calcium ions and the seaweed flour, the fine granulates of the starch carbohydrates will be encapsulated by a physical adaptation layer. The encapsulated granulate can be slowly dissolved only under the pH condition in the intestines, so that the nutriments like carbohydrates, protein and fat will be released slowly. The food with slowed release of nutriments that is produced via this invention is a source for healthy nutrition for the targeted group of people with high blood pressure, high cholesterin and overweight.

### CROSS REFERENCE TO RELATED APPLICATIONS

This application claims priority to Chinese Application No. 200510094957.8 filed Oct. 18, 2005.

### TECHNICAL AREA

This is a method for the production of food with slowed release of nutriments, which belongs to technologies for food production.

### BACKGROUND

Cereal is rich on starch carbohydrates and is an indispensable source of nutriments for human beings. The intake of cereal food shall not be lower than 150 g per day. Carbohydrates will be hydrolyzed by the starch enzymes released by the digestive organs, and quickly transformed into glucose, i.e. absorbed as glucose through the blood. The glucose in a healthy human body participates in the metabolism of the organs. The glucose of diabetic patients, however, can not participate in the normal metabolism. This results in the worsening of the diabetic condition. The same risk of high levels of blood sugar is also associated to persons with high cholesterin, overweight, high blood pressure—the so called metabolism disorders.

### DESCRIPTION OF THE INVENTION

The objective of this invention lies in the production method for food with slowed release of nutriments. Via this method, the nutriments of food like carbohydrates, protein, and fat will be slowly released, and in this way the level of blood sugar can be controlled. This method is therefore an invention for the effective regulation of blood sugar levels.

Technical Process of the Invention:

The refined seaweed flour will be mixed with warm water. The pH value of the resulting suspension fluid will be regulated. Afterwards, the suspension fluid will be cooled down and added to the selected cereal flour. The mixture will be evenly kneaded to a dumpling-like form. During the process it shall be avoided that the mixture overheats and boils. The mixture can then be left alone for sometime, and then be formed via press machines. After that the pre-formed food can be consolidated via baking, grilling, roasting, or it can be processed into a paste. At the time of consumption of the food or during the later stage of the processing, food-grade calcium shall be added in order to obtain food with slowed release of its nutriments.
(1) Proportion: the proportion of the refined seaweed flour shall be 0,5%˜8% of the total weight of the used cereal flour.
(2) Preparation of the seaweed sol: the refined seaweed flour will be mixed together with an appropriate amount of water to a suspension fluid. The fluid will be then changed to pH 8-11 under the temperature of 60˜80° C. The seaweed sol we obtained in this way shall then be cooled down to 10° C. The amount of the added water shall be sufficient for kneading the cereal flour to the dumpling-like form. The alkali solution for the regulation of the pH value can be food-grade Na₂CO₃ or food-grade NaOH
(3) Kneading: the cereal flour and seaweed sol shall be thoroughly and evenly mixed and kneaded to a dumpling-like form.
(4) Shaping/Forming: the cereal dumpling shall be processed to the needed form with the help of a presser.
(5) Consolidating: the food will be fixed via baking, grilling, roasting, drying, or processed into a paste.
(6) Preparation of the spice supplement: appropriate amount of spices or flavor additives, and food additive calcium can be mixed together to produce the spice supplement for the food. The amount of food-grade calcium shall be 0.1%˜2% of the total weight of the used cereal flour.

Before consumption of the food, one can heat the meal by putting together with the spice supplement in hot water, or cook them in water. Alternatively, one can also add the food-grade calcium during the kneading of the cereal flour and the seaweed sol, and mix the ingredients together to form and consolidate the food, in order to produce the food with slowed release of nutriments.

The aforementioned cereal flour can be made from rice flour, wheat flour, soy flour, potato flour or the mixture of several of these flours. Calcium lactate, calcium gluconate, calcium hydroxide, calcium chlorid can be used for the calcium additive. The aforementioned foods can be from the categories of noodle, instance noodle, rice noodle or instance rice noodle, cakes or bread.

The Useful Effects of the Invention:

Refined seaweed flour will be added to the cereal flour for the production of food. The resulting mixture will be processed via normal food processing methods to a variety of ready-to-serve meals. At the time of consumption of the food or during the later stage of the processing, food-grade calcium shall be added. Due to the consolidating effect of the calcium ions and the seaweed flour, the fine granulates of starch carbohydrates will be encapsulated with a physical adaptation layer. Such an encapsulated granulate can be dissolved only under the pH condition in the intestines, in order to release the nutrients like carbohydrates, proteins and fat. This kind of foods with slowed release of nutriments produced via this invention is an effective source of healthy food for the targeted group with high blood pressure level, high cholesterin, and with overweight.

Concrete Applications

### APPLICATION EXAMPLE 1

### Production of Fine Dried Noodles (Vermicelli) with Slowed Release of Nutriments

The major ingredient will be wheat flour (different types of wheat flour as needed). 100 kg of wheat flour, 8 kg of refined seaweed flour and 26 kg of 60-80° C. warm water is needed. The seaweed flour will be first mixed into a suspension fluid (with the warm water?), and then processed to a seaweed sol under pH 8-11 with the help of food-grade Na₂CO₃ or food-grade NaOH solution. The sol shall be now cooled down to 10° C. During the preparation of the seaweed sol, seaweed flour shall be added while the liquid is constantly being stirred, in order to avoid the building of clumps.

The 100 kg of wheat flour shall be mixed together with the seaweed sol. The mixture will then be stirred, kneaded, pressed, and dried in a drying room. The drying process shall consist of three phases—consolidating with lower temperature, drying with higher temperature, and then cooling with lower temperature. After the cooling phase, we can obtain about 84 kg of fine dried noodles as the final product. One can pack the fine dried noodles in portions of 70-100 g each in paper packs. A variety of spices can be used for the spice supplement. 0,1˜2 g calcium lactate shall be added for each package of spice supplement.

### APPLICATION EXAMPLE 2

### Production of Fine Dried Noodles (Vermicelli) with Slowed Release of Nutriments

0.5 kg of refined seaweed flour will be used. For the spice supplement in the spice package 0,1˜2 g calcium gluconate will be used instead of calcium lactate. Otherwise, the steps and ingredients will be the same as in example 1.

### APPLICATION EXAMPLE 3

### Production of Instant Noodles with Slowed Release of Nutriments

The composition is the same as in example 1. Wheat flour and seaweed sol will be fed into a horizontal double axles mix machine, where the mix will be stirred to crumbles. The pre-product can be pressed into thin noodle dough via coarse and fine pressers and several press steps. Via a cutting machine, the dough will be cut to wave noodles. The noodles then shall be cooked in a tunnel steam machine, and then cut into the required portions via a cutting machine. The noodle portions will be transferred via stainless steel convey channel to the frying pot to produce fried noodles, or transferred to hot air drying machine to get dried noodles. The noodles shall be dried quickly and then cooled down to room temperature via a cooling machine. The spice supplement can be prepared just like in example 1. The noodle portion and spice supplement shall be packed in vacuum packages, and finally packed in boxes and stored.

### APPLICATION EXAMPLE 4

### Production of Fine Rice Noodles with Slowed Release of Nutriments

High quality rice will be used, together with refined seaweed sol, which is prepared from refined seaweed flour that corresponds to 4% of the weight of the rice. For the production the rice will be dipped into water and soaked thoroughly, then dried, ground to flour, sieved, mixed with seaweed sol. The mixture will be stirred and steamed, then pressed and kneaded. Afterwards the pre-product will be formed, cut to rice boodles, dried and checked. The rice noodles can be packed in portions of 70-100 g each. Small portions of a variety of spices can be used for spice supplement. 0,1˜2 g calcium chlorid shall be added additionally.

### APPLICATION EXAMPLE 5

### Production of Bread with Slowed Release of Nutriments

Similarly one can produce bread with slowed release of nutriments. The flour dumpling shall be fermented. Food-grade calcium shall be added during the last stage of processing. Afterwards, the dumpling shall be formed to bread and baked in the oven. In this way one can obtain bread with slowed release of nutriments.

In essence, this is a method for the production of food which slowly releases its nutriments. The special features of this method are listed in the following:

The refined seaweed flour will be dissolved in suspension fluid with the help of warm water. The pH value of the suspension fluid will be regulated. Afterwards, the fluid will be cooled down and then thoroughly mixed with cereal flour and kneaded to a dumpling-like form. During the process it shall be avoided that the mixture overheats and boils. The mixture can then be left alone for some time, be formed in a presser and then be baked, gilled, roasted, or consolidated and processed to a paste. At the time of the consumption of the food, or during the later stage of the processing, calcium shall be added as a food additive in order to obtain food with gradual release of its nutriments.
(1) Proportion: the proportion of the refined seaweed flour shall be 0.5%˜8% of the total weight of the used cereal flour.
(2) Preparation of the seaweed solution: the refined seaweed flour will be mixed together with an appropriate amount of water to a suspension fluid. The fluid will be then changed to pH 8-11 using alkali solution under the temperature of 60˜80° C. The seaweed solution we obtain in this way shall then be cooled down to 10° C. The amount of the added water shall be sufficient for kneading the cereal flour to a dumpling-like form.
(3) Kneading: the cereal flour and seaweed solution shall be thoroughly mixed and kneaded to a dumpling-like form.
(4) Shaping/Forming: the cereal dumpling shall be processed to the needed form with the help of a presser.
(5) Consolidating: via baking, grilling, roasting, drying, or processing to paste, the food will be consolidated, or worked into a paste.
(6) Preparation of the spice supplement: appropriate amount of spices or flavor additives, and food calcium additive can be mixed to produce the spice supplement for the food. The amount of food calcium additive shall be 0.1%˜2% of the total weight of the used cereal flour.

Before consumption, one can warm the meal by putting it together with the spice supplement in hot water, or cook them in water. Alternatively, one can also add the food calcium during the kneading of the cereal flour and the seaweed solution, and mix the ingredients together to form and fix the food, in order to produce the food with gradual release of nutriments.

What is claimed is:

1. A method for the production of food which slowly releases its nutriments, the method of comprising the steps of;
dissolving refined seaweed flour in suspension fluid comprising warm water;
regulating the pH value of the suspension fluid between 8-11;
cool the suspension fluid;
mix the fluid with cereal flour to form a second mixture;
knead the seaweed mixture; and
add calcium to the kneaded mixture.

2. The method of claim 1 wherein said cereal flour selected from rice flour, wheat flour, soy flour, potato flour, and the mixture of one or more of these flours.

3. The method of claim 1 wherein said pH is regulated by adding an alkali solution selected from food grade Na₂CO₃, food grade NaOH, and mixtures thereof.

4. The method of claim 1 wherein said calcium is provided in a form selected from calcium lactate, calcium gluconate, calcium hydroxide, calcium chloride, and mixtures thereof.

5. The method of claim 1 further comprising the step of forming the kneaded mixture into categories of noodles, instance noodle, rice noodle or instance rice noodle, cakes or bread, or dumplings.
